(19) United States
(12) Patent Application Publication
(10) Pub. No.: US 2010/0013126 A1
(43) Pub. Date: Jan. 21, 2010

(54) PROCESS FOR PRODUCING NANO- AND MESOFIBERS BY ELECTROSPINNING COLLOIDAL DISPERSIONS

(76) Inventors: Michael Ishaque, Mannheim (DE); Michel Pepers, Ludwigshafen (DE); Walter Heckmann, Weinheim (DE); Evgueni Klimov, Ludwigshafen (DE); Andreas Greiner, Amoneburg (DE); Joachim H. Wendorff, Marburg (DE); Aleksandar Stoiljkovic, Pirot (RS)

Correspondence Address: CONNOLLY BOVE LODGE & HUTZ LLP, 1875 EYE STREET, N.W., SUITE 1100, WASHINGTON, DC, 20006, US

(21) Appl. No.: 12/438,296

(22) PCT Filed: Aug. 20, 2007
(86) PCT No.: PCT/EP07/58633

§ 371 Date: Feb. 20, 2009

(30) Foreign Application Priority Data
Aug. 21, 2006 (EP) 06119248.0

(51) Int. Cl. B29C 47/00

(52) U.S. Cl. 264/465

(57) ABSTRACT

The present invention relates to a process for producing polymer fibers, especially nano- and mesofibers, by the electrospinning process, in which a colloidal dispersion of at least one essentially water-insoluble polymer and of at least one nonionic surfactant, if appropriate further comprising at least one water-soluble polymer, is electrospun in an aqueous medium. The present invention further relates to fibers obtainable by this process.

The present invention relates to a process for producing polymer fibers, especially nano- and mesofibers, by electrospinning a colloidal dispersion of at least one essentially water-insoluble polymer in an aqueous medium, and to fibers obtainable by this process.

For the production of nano- and mesofibers, a multitude of processes are known to those skilled in the art, among which electrospinning is currently of the greatest significance. In this process, which is described, for example, by D. H. Reneker, H. D. Chun in Nanotech. 7 (1996), page 216 ff., a polymer melt or a polymer solution is typically exposed to a high electrical field at an edge which serves as an electrode. This can be achieved, for example, by extrusion of the polymer melt or polymer solution in an electrical field under low pressure by a cannula connected to one pole of a voltage source. Owing to the resulting electrostatic charge of the polymer melt or polymer solution, there is a material flow directed toward the counterelectrode, which solidifies on the way to the counterelectrode. Depending on the electrode geometries, nonwovens or assemblies of ordered fibers are obtained by this process.

DE-A-1-01 33 393 discloses a process for producing hollow fibers with an internal diameter of from 1 to 100 nm, in which a solution of a water-insoluble polymer—for example a poly-L-lactide solution in dichloromethane or a polyamide-46 solution in pyridine—is electrospun. A similar process is also known from WO-A1-01/09414 and DE-A1-103 55 665.

DE-A1-196 00 162 discloses a process for producing lawnmower wire or textile fabrics, in which polyamide, polyester or polypropylene as a thread-forming polymer, a maleic anhydride-modified polyethylene/polypropylene rubber and one or more aging stabilizers are combined, melted and mixed with one another, before this melt is melt-spun.

DE-A1-10 2004 009 887 relates to a process for producing fibers having a diameter of <50 μm by electrostatic spinning or spraying of a melt of at least one thermoplastic polymer.

The electrospinning of polymer melts allows only fibers of diameters greater than 1 μm to be produced. For a multitude of applications, for example filtration applications, however, nano- and/or mesofibers having a diameter of less than 1 μm are required, which can be produced with the known electrospinning processes only by use of polymer solutions.

However, these processes have the disadvantage that the polymers to be spun first have to be brought into solution. For water-insoluble polymers, such as polyamides, polyolefins, polyesters or polyurethanes, nonaqueous solvents—regularly organic solvents—therefore have to be used, which are generally toxic, combustible, irritant, explosive and/or corrosive.

In the case of water-soluble polymers, such as polyvinyl alcohol, polyethylene oxide, polyvinylpyrrolidone or hydroxypropylcellulose, it is possible to dispense with the use of nonaqueous solvents. However, fibers obtained in this way are by their nature water-soluble, which is why their industrial use is very limited. For this reason, these fibers have to be stabilized toward water after the electrospinning by at least one further processing step, for example by chemical crosslinking, which constitutes considerable technical complexity and increases the production costs of the fibers.

WO 2004/080681 A1 relates to apparatus and processes for the electrostatic processing of polymer formulations. The polymer formulations may be solutions, dispersions, suspensions, emulsions, mixtures thereof or polymer melts. One process mentioned for electrostatic processing is electrospinning. However, WO 2004/080681 A1 does not mention any specific polymer formulations which are suitable for electrospinning.

WO 2004/048644 A2 discloses the electrosynthesis of nanofibers and nanocomposite films. For the electrospinning, solutions of suitable starting substances are used. According to the description, the term “solvents” also comprises heterogeneous mixtures such as suspensions or dispersions. According to WO 2004/048644 A2, fibers can be produced, inter alia, from electrically conductive polymers. According to WO 2004/048644 A2, these are obtained preferably from the solutions comprising the corresponding monomers.

The application “Verfahren zur Herstellung von Nano- und Mesofasern durch Elektrospinning von kolloidalen Dispersionen” [Process for producing nano- and mesofibers by electrospinning colloidal dispersions] of Feb. 24, 2005 with the German reference number DE 10 2005 008 926.7, which has an earlier priority date but had not been published at the priority date of the present application, relates to a process for producing polymer fibers by electrospinning a colloidal dispersion of at least one essentially water-insoluble polymer in an aqueous medium. In this process, it was possible for the first time to spin aqueous polymer dispersions by means of an electrospinning process to obtain polymer fibers, especially nano- or mesofibers.

With the aid of the process described in DE 10 2005 008 926.7, it has been possible to avoid the aforementioned disadvantages of the prior art and to provide a process for producing water-stable polymer fibers, especially nano- and mesofibers, by the electrospinning process, in which the use of nonaqueous solvents to prepare a polymer solution and an aftertreatment of the electrospun fibers to stabilize them against water can be dispensed with.

It is an object of the present invention to provide a process optimized with respect to DE 10 2005 008 926.7 for electrospinning aqueous polymer dispersions, with which polymer fibers can be obtained with optimized structural and/or mechanical properties.

The object is achieved by the provision of a process in which a colloidal dispersion of at least one essentially water-insoluble polymer is electrospun in an aqueous medium.

In the process according to the invention, the colloidal dispersion comprises at least one nonionic surfactant.

The process according to the invention can provide fibers with a high water resistance which feature good mechanical stability. It is possible by the process according to the invention to produce nano- and mesofibers having a diameter of less than 1 μm from aqueous dispersions, such that the use of nonaqueous toxic, combustible, irritant, explosive and/or corrosive solvents can be avoided. Since the fibers produced by the process according to the invention are formed from essentially water-insoluble polymers, a subsequent process step for water stabilization of the fibers is not required.

In the process according to the invention for producing polymer fibers, a colloidal dispersion of at least one essentially water-insoluble polymer is electrospun in an aqueous medium. In the context of the present invention, essentially water-insoluble polymers are understood to mean especially polymers having a solubility in water of less than 0.1% by weight.

In the context of the present invention, in agreement with textbook knowledge, a dispersion refers to a mixture of at least two mutually immiscible phases, at least one of the at least two phases being liquid. Depending on the state of matter of the second or further phase, dispersions are divided into aerosols, emulsions and suspensions, the second or further phase being gaseous in aerosols, liquid in emulsions and solid in suspensions. In the process according to the invention, preference is given to using suspensions. The colloidal polymer dispersions to be used with preference in accordance with the invention are also referred to as latex in technical language.

In principle, the inventive colloidal polymer dispersions may be prepared by all processes known for this purpose to those skilled in the art, particularly good results being obtained especially by electrospinning latices produced by emulsion polymerization of suitable monomers. In general, the latex obtained by emulsion polymerization is used directly without further workup in the process according to the invention.

The aqueous medium in which the essentially water-insoluble polymer is present is generally water. In addition to water, the aqueous medium may comprise further additives, for example additives which are used to produce a latex in the emulsion polymerization of suitable monomers. Suitable additives are known to those skilled in the art.

According to the invention, the colloidal dispersion used for electrospinning comprises at least one nonionic surfactant.

It has been found that the addition of a nonionic surfactant to the colloidal dispersion used in the process according to the invention has a positive influence on the physical properties of the dispersion, for example viscosity, surface tension and conductivity, the process conditions and on the stability and morphology of the resulting fibers, especially nano- or mesofibers.

In the process according to the invention, it is possible in principle to use any surfactants known to those skilled in the art.

Without being bound to a theory, it is assumed that the use of nonionic surfactants achieves steric stabilization of the colloidal dispersion. This allows the mechanical stability of the fibers obtained by the process according to the invention to be improved. In addition, it has been found that the use of nonionic surfactants allows the formation of fibers by electrospinning to be improved over spraying of the colloidal polymer dispersion. It has also been found that the presence of nonionic surfactants can achieve a decrease in the viscosity of the colloidal dispersion, which makes possible the production of thinner and more compact fibers than without addition of nonionic surfactants. In addition, an increase in the conductivity of the dispersions and a decrease in the surface tension can be detected.

Suitable nonionic surfactants are known to those skilled in the art and are, for example, selected from the group consisting of surfactants comprising (oligo)oxyalkylene groups, surfactants comprising carbohydrate groups and amine oxides.

“(Oligo)oxyalkylene” —(OR¹)ₙ— is understood to mean that the surfactants comprising (oligo)oxyalkylene groups may have one or more oxyalkylene groups. In the general formula —(OR¹)ₙ—, R¹ is an alkylene group, preferably an alkylene group having 2 to 4 carbon atoms, and n is at least one, preferably from 3 to 30. As a result of the production, n is typically a mean value of the number of oxyalkylene groups. When n is greater than 1, the R¹ radicals in the n oxyalkylene groups may be the same or different.

Suitable surfactants comprising (oligo)oxyalkylene groups are, for example, selected from the group consisting of surfactants comprising (oligo)oxyethylene groups (polyethylene glycol groups), surfactants comprising (oligo)oxypropylene groups, surfactants comprising (oligo)oxybutylene groups, and surfactants which comprise two or more different oxyalkylene groups, e.g. (oligo)oxyethylene groups and (oligo)oxypropylene groups, in random distribution or in the form of blocks (block copolymer), for example block copolymers based on propylene oxide and ethylene oxide. The surfactants comprising (oligo)oxyalkylene groups are preferably selected from the group consisting of fatty alcohol alkoxylates, alkoxylated triglycerides and polyalkylene glycol ethers alkylated on both sides. Suitable alkoxylates or alkoxylated compounds are, for example, ethoxylates, propoxylates, butoxylates or random or block copolymers (or oligomers) formed from two or more different alkoxylates, e.g. ethoxylates and propoxylates.

Suitable surfactants comprising carbohydrate groups are, for example, selected from the group consisting of alkylpolyglycosides, sucrose esters, sorbitan esters (sorbitans), e.g. polyoxyethylene sorbitan trioleate, and fatty acid N-methyl-glucamides (fatty acid glucamides).

As is evident from the aforementioned group of surfactants, the nonionic surfactants suitable in accordance with the invention may comprise either (oligo)oxyalkylene groups or carbohydrate groups, or both (oligo)oxyalkylene groups and carbohydrate groups.

Suitable amine oxides are in particular alkyldimethylamine oxides.

It is possible to use individual surfactants or mixtures of two or more surfactants in the process according to the invention.

The aforementioned nonionic surfactants are known to those skilled in the art and are commercially available or preparable by processes known to those skilled in the art.

The nonionic surfactants used in accordance with the invention may in principle be present in the colloidal dispersions in amounts which do not lead to coagulation. The optimal amounts depend upon factors including the surfactant used and the use temperature. The at least one nonionic surfactant is present in the colloidal dispersions preferably in an amount of from 0.5 to 10% by weight, more preferably from 0.3 to 5% by weight, based on the total weight of the essentially water-insoluble polymer used. It has been found that particularly good process results—both in relation to the formation of the polymer fibers and in relation to the quality, for example the mechanical stability of the polymer fibers—are achieved when from 0.3 to 1% by weight, preferably from 0.5 to 1% by weight, based on the total weight of the dispersion, of the nonionic surfactant, for example of a block copolymer based on different alkylene oxides, for example based on propylene oxide and ethylene oxide, is used.

The at least one nonionic surfactant present in the colloidal dispersions in the process according to the invention can be added either actually during the preparation of the colloidal dispersions, especially of a polymer latex which is prepared by means of emulsion polymerization, or subsequently after the preparation of the colloidal dispersions, for example to the finished latex prepared by emulsion polymerization. In a preferred embodiment of the present invention, the at least one nonionic surfactant is added subsequently to the finished colloidal dispersion before the start of the electrospinning process.

In a preferred embodiment of the present invention, a colloidal aqueous dispersion of a water-insoluble polymer selected from the group consisting of poly(p-xylylene); polyvinylidene halides; polyesters such as polyethylene terephthalates, polybutylene terephthalate; polyethers; polyolefins such as polyethylene, polypropylene, poly(ethylene/propylene) (EPDM); polycarbonates; polyurethanes; natural polymers, for example rubber; polycarboxylic acids; polysulfonic acids; sulfated polysaccharides; polylactides; polyglycosides; polyamides; homo- and copolymers of aromatic vinyl compounds such as poly(alkyl)styrenes, e.g. polystyrenes, poly-α-methylstyrenes; polyacrylonitriles; polymethacrylonitriles; polyacrylamides; polyimides; polyphenylenes; polysilanes; polysiloxanes; polybenzimidazoles; polybenzothiazoles; polyoxazoles; polysulfides; polyesteramides; polyarylenevinylenes; polyether ketones; polyurethanes; polysulfones; inorganic-organic hybrid polymers such as ORMOCER®s from the Fraunhofer Gesellschaft zur Förderung der angewandten Forschung e.V. Munich; silicones; fully aromatic copolyesters; polyacrylates/polyalkyl acrylates; polymethacrylates/polyalkyl methacrylates; polyhydroxyethyl methacrylates; polyvinyl acetates; polyisoprene, synthetic rubbers such as chlorobutadiene rubbers, e.g. Neopren® from DuPont, nitrile-butadiene rubbers, e.g. Buna N®; polybutadiene; polytetrafluoroethylene; modified and unmodified celluloses, homo- and copolymers of α-olefins and copolymers formed from two or more of the monomer units which form the aforementioned polymers is used in the process according to the invention. All aforementioned polymers may be used in each case individually or in any combination with one another in the latices to be used in accordance with the invention, and in any mixing ratio.

Good results are achieved especially with homo- or copolymers based essentially on acrylates, aromatic vinyl compounds such as styrenes, α-methylstyrenes; vinyl acetates, vinyl ethers, butadienes, isoprenes, methacrylates, acrylamide, vinyl-sulfonic acid, vinylsulfonic esters, vinyl esters, vinyl alcohol, acrylonitrile, vinyl sulfones and/or vinyl halides.

In a particularly preferred embodiment of the present invention, the essentially water-insoluble polymers are selected from homo- or copolymers based essentially on aromatic vinyl compounds such as styrenes, α-methylstyrenes, acrylates, e.g. methyl or butyl acrylates, and/or methacrylates.

All of the aforementioned polymers may be used in uncrosslinked or crosslinked form provided that their solubility in water is less than 0.1% by weight.

The aforementioned essentially water-insoluble polymers are commercially available or can be prepared by processes known to those skilled in the art. In a preferred embodiment of the present invention, essentially water-insoluble polymers which are prepared by emulsion polymerization are used, suitable polymers obtainable by emulsion polymerization being mentioned above. The polymer latex obtained in the emulsion polymerization can—preferably after addition of the nonionic surfactant—be used directly as a colloidal dispersion in the electrospinning process according to the invention.

Particularly good results are achieved with colloidal polymer suspensions where the average weight-average particle diameter of the at least one essentially water-insoluble polymer is generally from 1 nm to 2.5 μm, preferably from 10 nm to 1.2 μm, more preferably from 15 nm to 1 μm. The average weight-average particle diameter of latex particles produced by emulsion polymerization, which are used in a preferred embodiment in the process according to the invention, is generally from 30 nm to 2.5 μm, preferably from 50 nm to 1.2 μm (determined according to W. Scholtan and H. Lange in Kolloid-Z. und Polymere 250 (1972), p. 782-796 by means of an ultracentrifuge). Very particular preference is given to using colloidal polymer suspensions, especially latices, in which the polymer particles have a weight-average particle diameter of from 50 nm to 500 nm, especially preferably from 50 nm to 250 nm.

The colloidal suspension used with preference in accordance with the invention may comprise particles with monomodal particle size distribution of the polymer particles or with bi- or polymodal particle size distribution. The terms monomodal, bimodal and polymodal particle size distribution are known to those skilled in the art.

When the latex to be used in accordance with the invention is based on two or more monomers, the latex particles may be arranged in any manner known to those skilled in the art. Mention should be made, for example, merely of particles with gradient structure, core-shell structure, salami structure, multicore structure, multilayer structure and raspberry morphology.

The term latex should also be understood to mean the mixture of two or more latices. The mixture can be prepared by all processes known for this purpose, for example by mixing two latices at any time before the mixing.

In a further preferred embodiment of the present invention, the colloidal dispersion comprises, in addition to the at least one water-insoluble polymer and the at least one nonionic surfactant, additionally at least one water-soluble polymer, water-soluble polymer in the context of the present invention being understood to mean a polymer having a solubility in water of at least 0.1% by weight.

Without being bound to a theory, the at least one water-soluble polymer which is preferably additionally present in the colloidal dispersions may serve as a so-called template polymer. With the aid of the template polymer, fiber formation from the colloidal polymer dispersion (electrospinning) is favored further over spraying (electrospraying). The template polymer serves as a kind of “adhesive” for the essentially water-insoluble polymers of the colloidal dispersion.

After the production of the polymer fibers by the process according to the invention, the water-soluble polymer is removed in a preferred embodiment of the process according to the invention, for example, by washing/extraction.

After removal of the water-soluble polymers, water-insoluble polymer fibers, especially nano- and microfibers, are obtained without disintegration of the polymer fibers.

The water-soluble polymer may be a homopolymer, copolymer, block polymer, graft copolymer, star polymer, highly branched polymer, dendrimer or a mixture of two or more of the aforementioned polymer types. According to the findings of the present invention, the addition of at least one water-soluble polymer accelerates/promotes not only fiber formation. Instead, the quality of the fibers obtained is also significantly improved.

In principle, all water-soluble polymers known to those skilled in the art can be added to the colloidal dispersion of at least one essentially water-insoluble polymer in an aqueous medium, particularly good results being achieved with water-soluble polymers selected from the group consisting of polyvinyl alcohol; polyalkylene oxides, e.g. polyethylene oxides; poly N-vinylpyrrolidone; hydroxymethylcelluloses; hydroxyethylcelluloses; hydroxypropylcelluloses; carboxymethylcelluloses; maleic acids; alginates; collagens; combinations formed from two or more monomer units which form the aforementioned polymers, copolymers formed from two or more monomer units which form the aforementioned polymers, graft copolymers formed from two or more monomer units which form the aforementioned polymers, star polymers formed from two or more monomer units which form the aforementioned polymers, highly branched polymers formed from two or more monomer units which form the aforementioned polymers, and dendrimers formed from two or more monomer units which form the aforementioned polymers.

In a preferred embodiment of the present invention, the water-soluble polymer is selected from polyvinyl alcohol, polyethylene oxides and poly-N-vinylpyrrolidone. The aforementioned water-soluble polymers are commercially available or can be prepared by processes known to those skilled in the art.

Irrespective of the embodiment, the solids content of the colloidal dispersion to be used in accordance with the invention—based on the total weight of the dispersion—is preferably from 5 to 60% by weight, more preferably from 10 to 50% by weight and most preferably from 10 to 40% by weight.

In the further embodiment of the present invention, the colloidal dispersion which is to be used in the process according to the invention and comprises at least one essentially water-insoluble polymer, at least one nonionic surfactant and if appropriate at least one water-soluble polymer in an aqueous medium, based on the total weight of the dispersion, comprises from 0 to 25% by weight, more preferably from 0.5 to 20% by weight and most preferably from 1 to 15% by weight, of at least one water-soluble polymer.

Thus, the colloidal dispersions used in accordance with the invention comprise, in a preferred embodiment, based in each case on the total amount of the colloidal dispersion,
i) from 5 to 60% by weight, preferably from 10 to 50% by weight, more preferably from 10 to 40% by weight, of at least one essentially water-insoluble polymer,
ii) from 0.1 to 10% by weight, preferably from 0.3 to 5% by weight, more preferably from 0.3 to 1% by weight, of at least one nonionic surfactant,
iii) from 0 to 25% by weight, preferably from 0.5 to 20% by weight, more preferably from 1 to 15% by weight, of at least one water-soluble polymer, and
iv) from 5 to 94.9% by weight, preferably from 10 to 89.2% by weight, more preferably from 15 to 88.5% by weight, of water.

The weight ratio of essentially water-insoluble polymer to the water-soluble polymer which is preferably present in the colloidal dispersion is dependent on the polymers used. For example, the essentially water-insoluble polymer and the water-soluble polymer used with preference may be used in a weight ratio of from 10:1 to 1:10, preferably from 9:1 to 1:9, more preferably from 8:2 to 2:8.

The colloidal dispersion to be used in accordance with the invention can be electrospun in all ways known to those skilled in the art, for example by extrusion of the dispersion, preferably of the latex, under low pressure through a cannula connected to one pole of a voltage source to a counterelectrode arranged at a distance from the cannula exit. The distance between the cannula and the counterelectrode functioning as the collector, and the voltage between the electrodes, is preferably adjusted in such a way that an electrical field of preferably from 0.5 to 2 kV/cm, more preferably from 0.75 to 1.5 kV/cm and most preferably from 0.8 to 1 kV/cm forms between the electrodes.

Good results are achieved especially when the internal diameter of the cannula is from 50 to 500 μm.

It has been found that the stability and compactness of the fibers produced by the process according to the invention can be improved further when the fibers—preferably after removal of the water-soluble polymer—are heated to a temperature above the glass transition temperature or the melting point of the polymer used in each case or of the polymer mixture used in each case. The temperature is dependent on the glass transition temperature or the melting point of the at least one water-insoluble polymer and is, for example, from 5 to 50° C., preferably from 10 to 40° C., more preferably from 15 to 30° C., above the glass transition temperature or the melting point of the particular at least one water-insoluble polymer. The heating is typically for a period of, for example, from 5 to 90 min, preferably from 10 to 60 min, preferably in a low-oxygen or oxygen-free atmosphere, for example under nitrogen or under argon.

Depending on the intended use of the fibers produced, it may be appropriate to subsequently bond them chemically to one another, or, for example, to crosslink them to one another by means of a chemical mediator. This allows, for example, the stability of one fiber layer formed by the fibers to be improved further, especially in relation to the water and thermal resistance.

The present invention further provides fibers, especially nano- and mesofibers, which are obtainable by the process according to the invention. The inventive fibers are notable in that, owing to the inventive addition of the at least one nonionic surfactant, they have structural and/or mechanical properties optimized compared to fibers which have been produced without addition of the nonionic surfactant, especially in relation to uniformity, compactness and stability.

The diameter of the inventive fibers is preferably from 10 nm to 50 μm, more preferably from 50 nm to 2 μm and most preferably from 100 nm to 1 μm. The length of the fibers depends upon the intended use and is generally from 50 μm up to several kilometers.

The process according to the invention allows the production not just of compact fibers but in particular also hollow fibers, especially those having an internal diameter of less than 1 μm and more preferably of less than 100 nm. For the production of such hollow fibers, the fibers produced with the aforementioned process according to the invention can be coated, for example, with a substance selected from the group consisting of inorganic compounds, polymers and metals, and then the water-insoluble polymer present on the inside can be degraded, for example thermally, chemically, biologically, by radiation-induced means, photochemically, by means of plasma, ultrasound or extraction with a solvent. The materials suitable for coating and the methods suitable for dissolving the intra-fiber material are described, for example in DE-A1-101 33 393.

The present invention further relates to colloidal dispersions of at least one essentially water-insoluble polymer in an aqueous medium which additionally comprises at least 0.5% by weight of a water-soluble polymer having a solubility in water of at least from 0.1% by weight and at least one nonionic surfactant.

In a preferred embodiment, the inventive colloidal dispersions comprise, based in each case on the total weight of the dispersion,
i) from 5 to 60% by weight, preferably from 10 to 50% by weight, more preferably from 10 to 40% by weight, of at least one essentially water-insoluble polymer,
ii) from 0.1 to 10% by weight, preferably from 0.3 to 5% by weight, more preferably from 0.3 to 1% by weight, of at least one nonionic surfactant,
iii) from 0 to 25% by weight, preferably from 0.5 to 20% by weight, more preferably from 1 to 15% by weight, of at least one water-soluble polymer, and
iv) from 5 to 94.9% by weight, preferably from 10 to 89.2% by weight, more preferably from 15 to 88.5% by weight, of water.

Suitable essentially water-insoluble polymers, aqueous media, water-soluble polymers and nonionic surfactants, and suitable amounts of these components in the colloidal dispersions, have been specified above. The inventive colloidal dispersions are used with preference in the process according to the invention.

The present invention further relates to the use of nonionic surfactants in a process for producing polymer fibers by an electrospinning process.

A preferred electrospinning process and suitable surfactants have been specified above.

The use of the nonionic surfactants in the electrospinning process can firstly achieve an improvement in the electrospinning process with regard to promotion of fiber formation (electrospinning) over spraying of the colloidal dispersion used with preference in the electrospinning process. The structural and mechanical properties of the polymer fibers produced by the electrospinning process can also be improved, especially in relation to the fiber quality, uniformity and stability, and the spinnability of the fibers.

Further aims, features, advantages and possible uses of the invention are evident from the description of working examples which follows and the drawings. All features described and/or shown in image form, alone or in any combination, form the subject matter of the invention, irrespective of their combination in the claims or the claims to which they refer back.

The figures show:

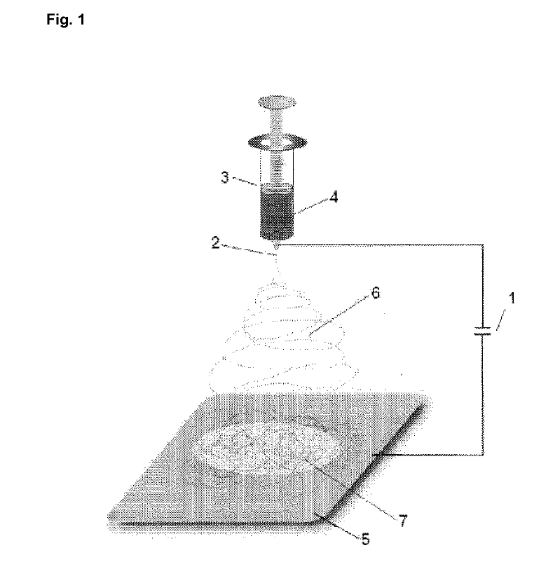

FIG. 1 a schematic illustration of an apparatus suitable for performing the electrospinning process according to the invention,

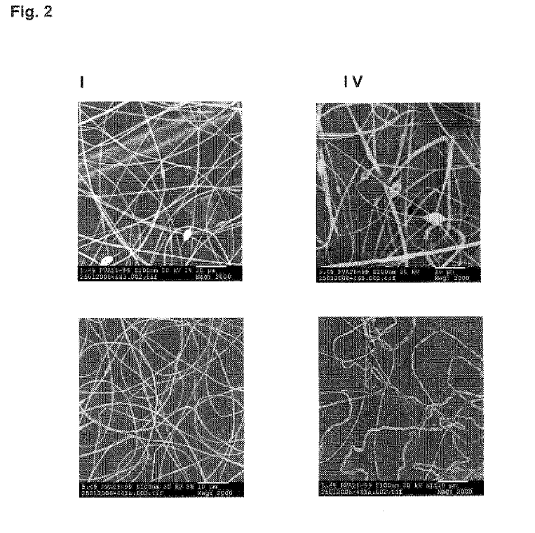

FIG. 2 scanning electron micrograph of the fibers obtained in example 2 before and after water treatment,

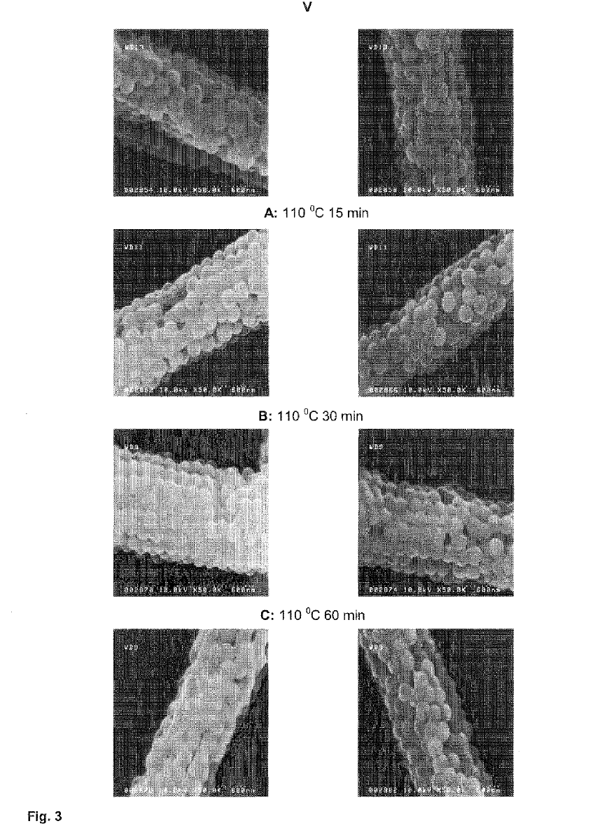

FIG. 3 scanning electron micrograph of the fibers obtained in example 3, heated to 110° C., before and after water treatment,

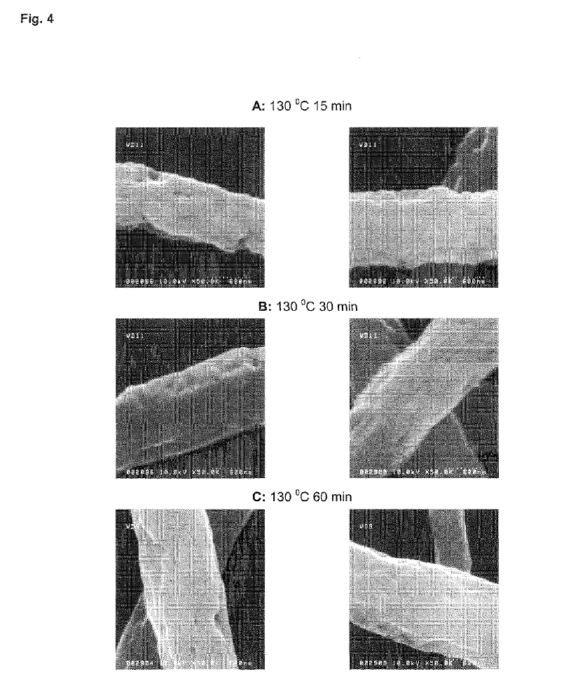

FIG. 4 scanning electron micrograph of the fibers obtained in example 3, heated to 130° C., before and after water treatment.

The electrospinning apparatus which is shown in FIG. 1 and is suitable for performing the process according to the invention comprises a syringe 3 which is provided at its tip with a capillary die 2 connected to one pole of a voltage source 1 and is for accommodating the inventive colloidal dispersion 4. Opposite the exit of the capillary die 2, at a distance of about 20 cm, is arranged a square counterelectrode 5 connected to the other pole of the voltage source 1, which functions as the collector for the fibers formed.

During the operation of the apparatus, a voltage between 18 kV and 35 kV is set at the electrodes 2, 5, and the colloidal dispersion 4 is discharged under a low pressure through the capillary die 2 of the syringe 3. Owing to the electrostatic charge of the essentially water-insoluble polymers in the colloidal dispersion which results from the strong electrical field of from 0.9 to 2 kV/cm, a material flow directed toward the counterelectrode 5 forms, which solidifies on the way to the counterelectrode 5 with fiber formation 6, as a consequence of which fibers 7 with diameters in the micro- and nanometer range are deposited on the counterelectrode 5.

With the aforementioned apparatus, in accordance with the invention, a colloidal dispersion of at least one essentially water-insoluble polymer and of at least one nonionic surfactant in an aqueous medium is electrospun.

The solids content within the dispersion is determined gravimetrically by means of a Mettler Toledo HR73 halogen moisture analyzer, by heating approx. 1 ml of the sample to 200° C. within 2 minutes and drying the sample to constant weight and then weighing it.

The mean particle size is the weight average d₅₀, determined by means of an analytical ultracentrifuge (according to W. Scholtan and H. Lange in Kolloid-Z. und Polymere 250 (1972), p. 782-796).

The size, i.e. the diameter and the length of the fibers, is determined by evaluating electron micrographs.

### 1. Preparation of the Colloidal Dispersions

### 1.1 General Method

The polymer latex used in the examples which follow comprises polystyrene in an amount of 40% by weight based on the total weight of the polymer latex. The mean particle size (weight average, d₅₀) is 100 nm (example 1, 2) or 200 nm (example 3).

Polymer latices comprising polystyrene with the aforementioned particle sizes are prepared by customary processes known to those skilled in the art. Typically, a polymer latex having a polystyrene content of >30% by weight is obtained, which is then diluted to the desired concentration with water.

The water-soluble polymer used is poly(vinyl alcohol) (PVA I) which has a weight-average molecular weight (M_{w}) of 195000 g/mol and has been 98% hydrolyzed (MOWIOL® 56-98 from Kuraray Specialities Europe KSE GmbH), or poly(vinyl alcohol) (PVA II) which has a weight-average molecular weight (M_{w}) of 145 000 g/mol and has been 99% hydrolyzed (MOWIOL® 28-99 from Kuraray Specialities Europe KSE).

The nonionic surfactant used is a block copolymer based on propylene oxide and ethylene oxide (Basensol® from BASF AG).

The colloidal dispersions used for electrospinning in example 2 are prepared by mixing a polystyrene-comprising latex with water to obtain the aforementioned polymer latex comprising polystyrene in an amount of 40% by weight based on the total weight of the polymer latex. The solids content of the dispersion to be spun is 18% by weight. The aforementioned polyvinyl alcohol is added to the polymer latex in aqueous solution (10% by weight), so that the colloidal dispersion to be spun comprises approx. 4.5% by weight of PVA II and the weight ratio of polystyrene to polyvinyl alcohol (PVA II) in the mixture is 80:20. The nonionic surfactant is added to this mixture, the amount of the nonionic surfactant in the colloidal dispersion to be spun being approx. 0.5% by weight.

In a comparative experiment, a corresponding colloidal dispersion without addition of a nonionic surfactant is spun.

### 1.2 Example Dispersions

In table 1, the colloidal dispersions to be spun are summarized:

| | Amount | | Amount of the | | Amount of | | |
|---|---|---|---|---|---|---|---|
| | of the | Amount | PVAII solution | Amount | Basensol ® | | Amount |
| | PS-latex | of PS³⁾ | used, 10% | of PVAII³⁾ | solution, 5% | Amount of | of |
| | used²⁾ | [% by | strength by | [% by | strength by | Basensol ® | water⁵⁾ |
| Example | [g] | wt.] | weight [g]⁴⁾ | wt.] | weight [g]⁴⁾ | [% by wt.] | [g] |
| 1 | 14.99 g | 17.7% | 15.03 g | 4.4% by | 3.59 g | 0.5% by | 0.30 |
| | | by wt. | | wt. | | wt. | |
| IV¹⁾ | 15.00 g | 17.9% | 15.00 g | 4.5% by | / | / | 3.70 |
| | | by wt. | | wt. | | | |

¹⁾Comparison
²⁾PS = polystyrene having a mean particle size of 100 nm in water (approx. 40% strength by weight)
³⁾Based on the total weight of the dispersion
⁴⁾Aqueous solution
⁵⁾Amount of water added additionally
⁶⁾Basensol ®: block copolymer based on propylene oxide and ethylene oxide from BASF AG

### 2. Electrospinning of the Dispersions Prepared

The colloidal dispersions I and IV prepared in number 1 are electrospun in the apparatus shown in FIG. 1.

The dispersion is conveyed with a sample feed rate of 0.7 ml/h at a temperature of from 15 to 16° C. through a syringe 3 with a capillary die 2 having an internal diameter of 0.3 mm provided at its tip, the separation of the electrodes 2, 5 being 200 ml and a voltage of 30 kV being applied between the electrodes. To remove the water-soluble polymer, the resulting fibers are treated with water at room temperature for 17 hours.

FIG. 2 shows the scanning electron micrographs of the fibers produced from the colloidal dispersions I (left) and IV (right). In the upper diagrams, the resulting fibers before the treatment with water in each case are shown, and, in the lower diagrams, the corresponding fibers after the treatment with water.

In FIG. 2:

I means fibers resulting from electrospinning of the dispersion I;
IV means fibers resulting from electrospinning of the dispersion IV.

As is evident from FIG. 2, addition of nonionic surfactant affords more uniform polymer fibers than without addition of surfactant, which do not dissolve into individual polystyrene particles in water.

3. Heating of Polymer Fibers Produced in Accordance with the Invention to Temperatures Above the Glass Transition Temperature

### 3.1 Dispersions Used and Conditions of the Electrospinning:

A colloidal dispersion based on a 40% by weight polystyrene latex is used. The weight-average particle size of the polystyrene particles (d₅₀) is 200 nm. The dispersion comprises 4.5% by weight, based on the total amount of the dispersion, of polyvinyl alcohol PVA II, the weight ratio of polystyrene to PVA II being 85:15, and 0.8% by weight, based on the total amount of the dispersion, of the nonionic surfactant.

In table 2 below, the components of the colloidal dispersion to be spun and their amounts are summarized:

| | Amount | Amount | Amount of the | | | |
|---|---|---|---|---|---|---|
| | of the PS | of PS²⁾ | PVAII solution | Amount of | Amount of | Amount of |
| | latex | [% by | used, 13% strength | PVAII²⁾ [% | Basensol ®⁴⁾ | Basensol ® |
| | used¹⁾ [g] | wt.] | by weight [g]³⁾ | by wt.] | [g] | [% by wt.] |
| Dispersion | 17.81 g | 25.7% | 9.60 g | 4.5% by | 0.21 g | 0.8% by |
| used | | by wt. | | wt. | | wt. |

¹⁾PS = polystyrene having a mean particle size of 200 nm in water (40% strength by weight)
²⁾Based on the total weight of the dispersion
³⁾Aqueous solution
⁴⁾Basensol ®: Block copolymer based on propylene oxide and ethylene oxide from BASF AG

The electrospinning is carried out in the apparatus shown in FIG. 1, under the following conditions:

| | | |
|---|---|---|
| Internal diameter of the capillary die: | 0.3 | mm |
| Sample feed rate: | 0.7 | ml/h |
| Separation of the electrodes 2, 5: | 200 | mm |
| Voltage between the electrodes: | 10 | kV. |

To remove the water-soluble polymer, the resulting fibers are treated with water at room temperature for 17 hours.

Some of the fibers obtained after the electrospinning are heated before the treatment with water at temperatures of in each case 110° C. and 130° C., in each case for 15, 30 and 60 minutes. The rest of the resulting fibers are heated under the corresponding conditions after the treatment with water.

FIGS. 3 and 4 show scanning electron micrographs of the corresponding fibers in comparison to unheated fibers. On the left-hand side, images of fibers which have not been treated with water before the heating are shown in each case, and, on the right-hand side, images of fibers which have been treated with water before the heating are shown in each case. FIG. 3 shows images of fibers which have been heated at 110° C., and FIG. 4 shows images of fibers which have been heated at 130° C. In addition, FIG. 3, for comparison, shows a fiber (before and after water treatment) which has not been heated.

In FIG. 3:

V means without heating.

In FIGS. 3 and 4, in each case:

A means heating for 15 minutes to 110° C. (FIG. 3) or 130° C. (FIG. 4)
B means heating for 30 minutes to 110° C. (FIG. 3) or 130° C. (FIG. 4)
C means heating for 60 minutes to 110° C. (FIG. 3) or 130° C. (FIG. 4)

In the images in FIGS. 3 and 4, it can be seen clearly that smoothing of the fibers can be achieved by the heating.

The invention is not restricted to one of the embodiments described, but rather can be modified in various ways. However, it can be seen that the present invention relates to a process for producing polymer fibers, especially nano- and mesofibers, by the electrospinning process, in which a colloidal dispersion of at least one essentially water-insoluble polymer (and of at least one nonionic surfactant), if appropriate further comprising at least one water-soluble polymer, is electrospun in an aqueous medium. The present invention further relates to fibers obtainable by this process.

All advantages and features evident from the claims, the description and the drawing, including construction details, spatial arrangements and process steps, may be essential to the invention either alone or in a wide variety of different combinations.

### REFERENCE NUMERAL LIST

1 Voltage source
2 Capillary die
3 Syringe
4 Colloidal dispersion
5 Counterelectrode
6 Fiber formation
7 Fiber mat

1-18. (canceled)

19. A process for producing polymer fibers by electrospinning a colloidal dispersion of at least one essentially water-insoluble polymer in an aqueous medium, wherein the colloidal dispersion comprises at least one nonionic surfactant.

20. The process according to claim 19, wherein the at least one nonionic surfactant is selected from the group consisting of surfactants comprising (oligo)oxyalkylene groups, surfactants comprising carbohydrate groups and amine oxides.

21. The process according to claim 19, wherein the at least one nonionic surfactant is used in an amount of from 0.1 to 10% by weight, based on the total weight of the dispersion.

22. The process according to claim 19, wherein the at least one essentially water-insoluble polymer has a solubility in water of less than 0.1% by weight.

23. The process according to claim 19, wherein the at least one essentially water-insoluble polymer is selected from the group consisting of poly(p-xylylene); polyvinylidene halides; polyesters; polyethers; polyolefins; polycarbonates; polyurethanes; natural polymers; polycarboxylic acids; polysulfonic acids; sulfated polysaccharides; polylactides; polyglycosides; polyamides; homo- and copolymers of aromatic vinyl compounds; polyacrylonitriles; polymethacrylonitriles; polyacrylamides; polyimides; polyphenylenes; polysilanes; polysiloxanes; polybenzimidazoles; polybenzothiazoles; polyoxazoles; polysulfides; polyesteramides; polyarylenevinylenes; polyether ketones; polyurethanes; polysulfones; inorganic-organic hybrid polymers; silicones; fully aromatic copolyesters;
polyacrylates/polyalkyl acrylates; polymethacrylates/polyalkyl methacrylates; polyhydroxyethyl methacrylates; polyvinyl acetates; polyisoprene; synthetic rubbers; polybutadiene; polytetrafluoroethylene; modified and unmodified celluloses; homo- and copolymers of α-olefins; copolymers formed from two or more of the monomer units which form the aforementioned polymers, and combinations thereof.

24. The process according to claim 23, wherein the at least one essentially water-insoluble polymer is a homo- or copolymer based essentially on acrylates, aromatic vinyl compounds such as styrenes and α-methylstyrenes, vinyl acetates, vinyl ethers, butadienes, isoprenes, methacrylates, acrylamide, vinylsulfonic acid, vinylsulfonic esters, vinyl esters, vinyl alcohol, acrylonitrile, vinyl sulfones and/or vinyl halides.

25. The process according to claim 19, wherein the average weight-average particle diameter of the at least one essentially water-insoluble polymer is between 1 nm and 2.5 μm.

26. The process according to claim 19, wherein the colloidal dispersion additionally comprises at least one water-soluble polymer having a solubility in water of at least 0.1% by weight.

27. The process according to claim 26, wherein the water-soluble polymer is selected from the group consisting of homopolymers, copolymers, graft copolymers, star polymers, highly branched polymers and dendrimers.

28. The process according to claim 26, wherein the water-soluble polymer is selected from the group consisting of polyvinyl alcohol, polyalkylene oxides, poly N-vinylpyrrolidone, hydroxymethylcelluloses, hydroxyethylcelluloses, hydroxypropylcelluloses, carboxymethylcelluloses, maleic acids, alginates, collagens, combinations formed from two or more monomer units which form the aforementioned polymers, copolymers formed from two or more monomer units which form the aforementioned polymers, graft copolymers formed from two or more monomer units which form the aforementioned polymers, star polymers formed from two or more monomer units which form the aforementioned polymers, highly branched polymers formed from two or more monomer units which form the aforementioned polymers, and dendrimers formed from two or more monomer units which form the aforementioned polymers.

29. The process according to claim 19, wherein the solids content of the colloidal dispersion, based on the total weight of the dispersion, is from 5 to 60% by weight.

30. The process according to claim 19, wherein the colloidal dispersion, based on the total weight of the dispersion, comprises from 0 to 25% by weight of a water-soluble polymer.

31. The process according to claim 19, wherein the fibers obtained after the electrospinning are heated to a temperature above the glass transition temperature or the melting point of the at least one essentially water-insoluble polymer used.

32. A fiber obtainable by a process according to claim 19.

33. The fiber according to claim 32, which has a diameter of from 10 nm to 50 μm.

34. The fiber according to claim 32, which has a length of at least 50 μm.

35. A colloidal dispersion of at least one essentially water-insoluble polymer comprising
i) from 5 to 60% by weight, preferably from 10 to 50% by weight, more preferably from 10 to 40% by weight, of at least one essentially water-insoluble polymer,
ii) from 0.1 to 10% by weight, preferably from 0.3 to 5% by weight, more preferably from 0.3 to 1% by weight, of at least one nonionic surfactant,
iii) from 0 to 25% by weight, preferably from 0.5 to 20% by weight, more preferably from 1 to 15% by weight, of at least one water-soluble polymer, and
iv) from 5 to 94.9% by weight, preferably from 10 to 89.2% by weight, more preferably from 15 to 88.5% by weight, of water,
in an aqueous medium further comprising at least 0.5% by weight, based on the total weight of the dispersion, of a water-soluble polymer having a solubility in water of at least 0.1% by weight and at least one nonionic surfactant.

36. A process for producing polymer fibers by an electrospinning process, comprising the step of electrospinning a colloidal dispersion of at least one essentially water-insoluble polymer in an aqueous medium further comprising at least 0.5% by weight, based on the total weight of the dispersion, of a water-soluble polymer having a solubility in water of at least 0.1% by weight and at least one nonionic surfactant.

37. The process according to claim 20, wherein the at least one nonionic surfactant is used in an amount of from 0.1 to 10% by weight, based on the total weight of the dispersion.

38. The process according to claim 20, wherein the at least one essentially water-insoluble polymer has a solubility in water of less than 0.1% by weight.
